(19) United States
(12) Patent Application Publication
(10) Pub. No.: US 2025/0138301 A1
(43) Pub. Date: May 1, 2025

(54) ELECTROMAGNETIC WAVE DEFLECTION DEVICE AND ELECTROMAGNETIC WAVE SCANNING DEVICE

(71) Applicant: KYOCERA Corporation, Kyoto (JP)

(72) Inventor: Hiroki OKADA, Machida-shi, Tokyo (JP)

(73) Assignee: KYOCERA Corporation, Kyoto (JP)

(21) Appl. No.: 18/835,092

(22) PCT Filed: Feb. 6, 2023
(86) PCT No.: PCT/JP2023/003853

§ 371 Date: Aug. 1, 2024

(30) Foreign Application Priority Data
Feb. 10, 2022 (JP) 2022-019760

(51) Int. Cl. G02B 26/08

(52) U.S. Cl. CPC G02B 26/0816

(57) ABSTRACT

An electromagnetic wave deflection device includes a mirror configured to reflect an electromagnetic wave, a housing that accommodates the mirror and includes an opening, and a transmissive member provided in the opening. The transmissive member is configured to transmit at least part of the electromagnetic wave. The housing includes a bottom surface positioned on an opposite side from the opening. The mirror is accommodated in the housing so as to be inclined relative to the bottom surface.

### CROSS-REFERENCE TO RELATED APPLICATIONS

The present application claims priority to Japanese Patent Application No. 2022-19760, filed in the Japanese Patent Office on Feb. 10, 2022, the entire contents of which are incorporated herein by reference.

### TECHNICAL FIELD

The present disclosure is related to an electromagnetic wave deflection device and an electromagnetic wave scanning device.

### BACKGROUND OF INVENTION

A known mirror unit includes a transmissive member inclined relative to a MEMS (micro electro mechanical systems) mirror to suppress noise (for example, Patent Literature 1).

### CITATION LIST

### Patent Literature

Patent Literature 1: Japanese Unexamined Patent Application Publication No. 2020-122961

### SUMMARY

In an embodiment of the present disclosure, an electromagnetic wave deflection device includes a mirror configured to reflect an electromagnetic wave, a housing that accommodates the mirror and includes an opening, and a transmissive member provided in the opening. The transmissive member is configured to transmit at least part of the electromagnetic wave. The housing includes a bottom surface positioned on an opposite side from the opening. The mirror is accommodated in the housing so as to be inclined relative to the bottom surface.

In an embodiment of the present disclosure, an electromagnetic wave scanning device includes the electromagnetic wave deflection device and a radiation unit configured to cause the electromagnetic wave to be incident upon the transmissive member at a predetermined angle.

### BRIEF DESCRIPTION OF THE DRAWINGS

FIG. 1 is a plan view illustrating a configuration example of an electromagnetic wave deflection device according to an embodiment of the present disclosure.

FIG. 2 is a sectional view taken along line A-A illustrated in FIG. 1.

FIG. 3 is a sectional view illustrating an example of a traveling direction of an electromagnetic wave when a mirror is rotated and inclined about a first axis.

FIG. 4 is a sectional view illustrating an example of a traveling direction of an electromagnetic wave when a mirror is rotated and inclined about a first axis and a second axis.

FIG. 5 is a sectional view illustrating a configuration example of a transmissive member 30 including a projection at a surface of the transmissive member 30.

FIG. 6 is a sectional view illustrating an example of the traveling direction of the electromagnetic wave when the mirror is rotated and inclined about the first axis in the configuration example illustrated in FIG. 5.

### DESCRIPTION OF EMBODIMENTS

When a housing in which a MEMS (micro electro mechanical systems) mirror is placed is sealed with an inclined transmissive member, the sealing performance is unlikely to be ensured. Both reducing of noise and ensuring of the sealing performance are required to be realized. In an embodiment of the present disclosure, with an electromagnetic wave deflection device and an electromagnetic wave scanning device, both the reducing of noise and the ensuring of the sealing performance can be realized.

### Configuration Example of Electromagnetic Wave Deflection Device 1

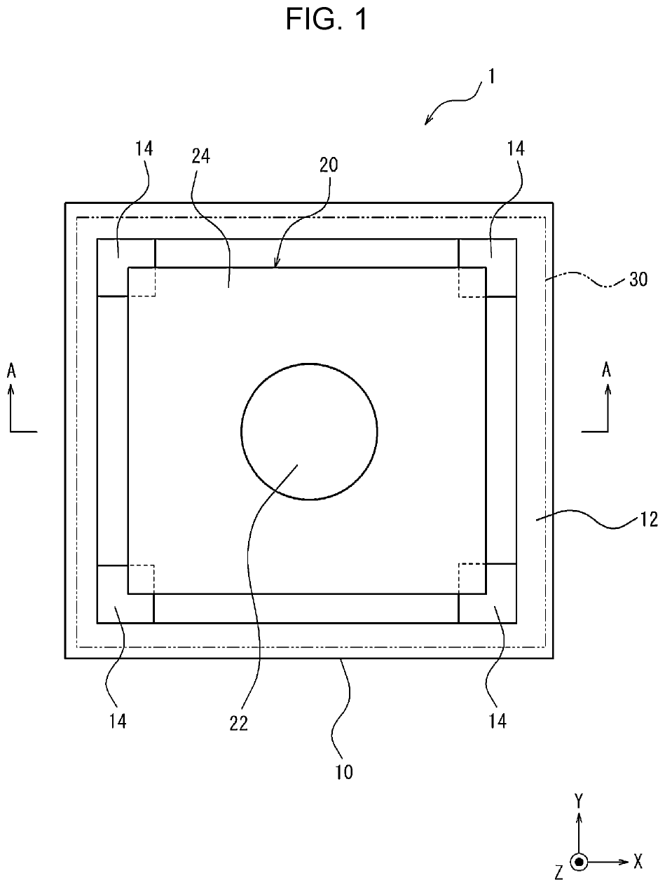

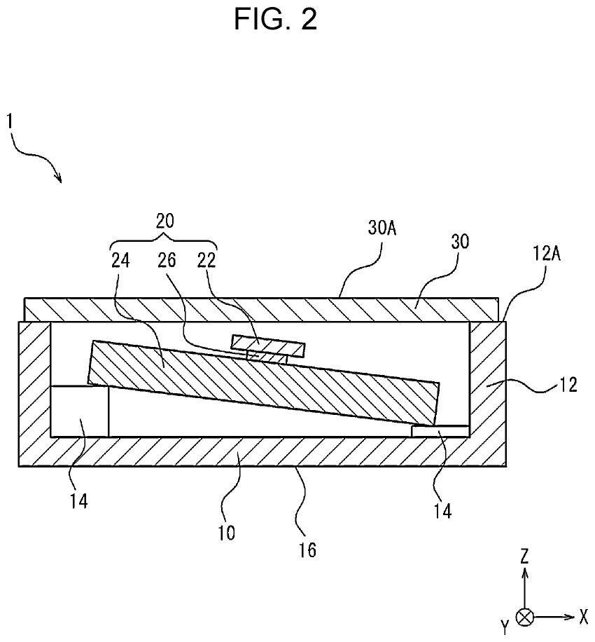

As illustrated in FIGS. 1 and 2, in an embodiment, an electromagnetic wave deflection device 1 includes a housing 10, a reflection device 20, and a transmissive member 30. The housing 10 accommodates the reflection device 20. The transmissive member 30 is joined to the housing 10 with the reflection device 20 accommodated in the housing 10. When the housing 10 and the transmissive member 30 are joined to each other, the reflection device 20 is sealed inside. The reflection device 20 reflects an incident electromagnetic wave from the outside through the transmissive member 30 and emits the electromagnetic wave to the outside through the transmissive member 30.

The housing 10 includes side walls 12, placement portions 14, and a bottom surface 16. The side walls 12 are positioned so as to surround the housing 10. The housing 10 is joined to the transmissive member 30 at upper ends 12A of the side walls 12. The side walls 12 are configured such that a posture of the transmissive member 30 is substantially horizontal or horizontal when the transmissive member 30 is joined to the upper ends 12A. Specifically, the difference in height of upper ends 12A between positions of the side walls 12 may be reduced. The housing 10 can also be said to include an opening formed by being surrounded by the upper ends 12A of the side walls 12. The transmissive member 30 can also be said to be provided at the opening of the housing 10.

The placement portions 14 allows the reflection device 20 to be placed thereon. The placement portions 14 support the reflection device 20 at four positions illustrated in FIG. 1. The number of positions where the reflection device 20 is supported by the placement portions 14 may be equal to or smaller than three positions or equal to or greater than five positions. Although the placement portions 14 support the reflection device 20 at corners of the reflection device 20 in FIG. 1, the placement portions 14 may support side portions of the reflection device 20 or at least part of a back surface of the reflection device 20.

In the electromagnetic wave deflection device 1, the bottom surface 16 corresponds to an opposite surface from the transmissive member 30. In other words, the bottom surface 16 corresponds to a surface positioned on an opposite side from a side where the transmissive member 30 is joined (opening). During use of the electromagnetic wave deflection device 1, the bottom surface 16 may face in a vertical direction (direction on which gravity acts) or a direction other than the vertical direction. The bottom surface 16 is assume to face in the vertical direction when the transmissive member 30 is joined to the housing 10. The transmissive member 30 is joined to the upper ends 12A of the side walls 12 of the housing 10 while the bottom surface 16 of the housing 10 is in contact with a workbench or the like. As a result, the transmissive member 30 is joined so as to be positioned substantially parallel or parallel to the bottom surface 16. The bottom surface 16 is assumed to extend along the XY plane. In other words, a normal line to the bottom surface 16 extends along the Z axis. Furthermore, a normal line to a surface 30A of the transmissive member 30 is assumed to extend along the Z axis.

The transmissive member 30 transmits the electromagnetic wave incident upon the reflection device 20 and the electromagnetic wave reflected by the reflection device 20. The transmissive member 30 may include glass, resin, or the like. The transmissive member 30 includes the surface 30A facing outside a space sealing the reflection device 20. The transmissive member 30 can be said to seal the reflection device 20 when the transmissive member 30 is joined to the housing 10.

The reflection device 20 includes a mirror 22 configured to reflect the electromagnetic wave and a substrate 24 holding the mirror 22. The mirror 22 inclinable relative to the substrate 24. The reflection device 20 may further include a driver 26 configured to incline the mirror 22. That is, the reflection device 20 is configured so as to be able to control the posture of the mirror 22. The mirror 22 may include metal, a semiconductor, resin, or the like. The substrate 24 may include resin, ceramic, a semiconductor, metal, or the like. The driver 26 may include an actuator such as a piezoelectric element or a motor. The mirror 22 and the driver 26 may be formed on the substrate 24 through a production process based on a MEMS technique.

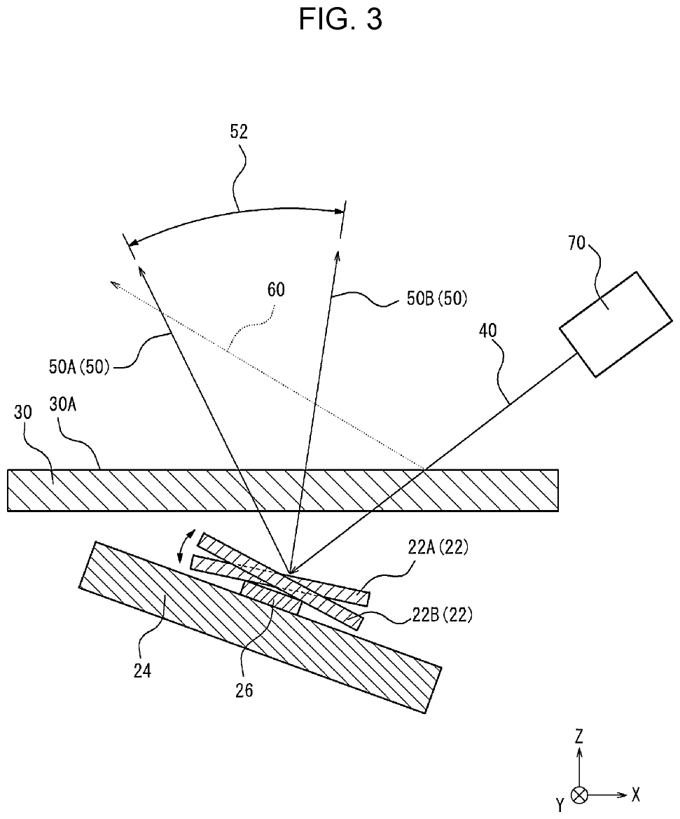

The mirror 22 may be inclinable relative to the substrate 24 about an axis extending in a direction perpendicular to the page of FIG. 3 (axis extending along the Y axis) as exemplified in FIG. 3. The axis extending in the direction perpendicular to the page of FIG. 3 (axis extending along the Y axis) is also referred to as a first axis. The first axis can also be said to extend in a direction along the substrate 24. The mirror 22 may be inclinable about the first axis. A mirror 22A indicates the mirror 22 rotated and inclined counterclockwise about the first axis by a maximum angle. A mirror 22B indicates the mirror 22 rotated and inclined clockwise about the first axis by a maximum angle.

The electromagnetic wave incident upon the reflection device 20 is also referred to as an incident electromagnetic wave 40. The electromagnetic wave reflected by the reflection device 20 is also referred to as a reflected electromagnetic wave 50. The reflected electromagnetic wave 50 travels in a direction indicated as a reflected electromagnetic wave 50A when the mirror 22 is inclined counterclockwise most as indicates as the mirror 22A. The reflected electromagnetic wave 50 travels in a direction indicated as a reflected electromagnetic wave 50B when the mirror 22 is inclined clockwise most as indicated as the mirror 22B. When the mirror 22 is inclined in a state between a state indicated as the mirror 22A and a state indicated as the mirror 22B, the reflected electromagnetic wave 50 travels in a direction between the direction of the reflected electromagnetic wave 50A and the direction of the reflected electromagnetic wave 50B. That is, the reflected electromagnetic wave 50 is scanned between the direction of the reflected electromagnetic wave 50A and the direction of the reflected electromagnetic wave 50B due to variation of an inclination angle of the mirror 22. A range in which the reflected electromagnetic wave 50 is scanned is also referred to as a scanning range 52. When the mirror 22 is inclined about a single axis, the reflected electromagnetic wave 50 is linearly (one-dimensionally) scanned. That is, the scanning range 52 is represented as a linear range.

At least part of the incident electromagnetic wave 40 is transmitted through the transmissive member 30 and incident upon the reflection device 20. Meanwhile, part of the incident electromagnetic wave 40 is reflected by the surface 30A of the transmissive member 30. The electromagnetic wave reflected by the surface 30A of the transmissive member 30 travels in a certain direction regardless of a scanning direction of the reflected electromagnetic wave 50. The electromagnetic wave reflected by the surface 30A of the transmissive member 30 is also referred to as a reflected wave. Furthermore, the electromagnetic wave reflected by the surface 30A of the transmissive member 30 is an unnecessary electromagnetic wave for scanning of the reflected electromagnetic wave 50 in the scanning range 52 and also referred to as a noise electromagnetic wave 60.

The reflection device 20 controls the inclination of the mirror 22 so as to equalize intensity of the reflected electromagnetic wave 50 reaching various parts (so as to reduce the difference between integral values of the intensity of the electromagnetic wave having reached various parts) included in the scanning range 52 during a single period of scanning. If the noise electromagnetic wave 60 travels in the scanning range 52, the integral value of the intensity of the electromagnetic wave increases only in part where the noise electromagnetic wave 60 travels.

In the present embodiment, the electromagnetic wave deflection device 1 causes the noise electromagnetic wave 60 (reflected wave) to travel to the outside of the scanning range 52. Specifically, the substrate 24 of the reflection device 20 may be placed on the placement portions 14 such that the substrate 24 is inclined relative to the bottom surface 16 of the housing 10 about the axis in the direction along the first axis serving as the axis about which the mirror 22 is inclined. In other words, the mirror 22 may be accommodated in the housing 10 while the mirror 22 is inclined relative to the bottom surface 16. In the example illustrated in FIG. 3, the axis along the first axis serving as the axis about which the mirror 22 is inclined corresponds to the axis extending in the direction perpendicular to the page of FIG. 3 (axis extending along the Y axis). When the substrate 24 is inclined relative to the bottom surface 16, the electromagnetic wave deflection device 1 can move the scanning range 52 such that the traveling direction of the noise electromagnetic wave 60 is to the outside the scanning range 52. The traveling direction of the noise electromagnetic wave 60 is determined by the surface 30A of the transmissive member 30. As a result, the noise during the scanning of the electromagnetic wave in the scanning range 52 can be reduced. The posture of the mirror 22 can be said to be able to be controlled such that, by inclining the substrate 24 relative to the bottom surface 16, a reflection surface for the electromagnetic wave is not parallel to the transmissive member 30.

The substrate 24 of the reflection device 20 may be placed on the placement portions 14 so as to be rotated and inclined, by an angle greater than a predetermined angle, relative to the bottom surface 16 of the housing 10 about the axis in the direction along the first axis serving as the axis about which the mirror 22 is inclined. The direction in which the substrate 24 is inclined may be clockwise or counterclockwise about the axis.

The predetermined angle is determined based on an angle by which the mirror 22 is inclined. The mirror 22 is inclined by the maximum inclination angle about the axis clockwise and counterclockwise with reference to a state of the mirror 22 substantially parallel or parallel to the substrate 24 as a reference posture. A maximum clockwise inclination angle and a maximum counterclockwise inclination angle are assumed to be equal to each other. In this case, the predetermined angle may be set to an angle double the maximum inclination angle. The reason for this is that an angle between the following traveling directions is double the inclination angle of the mirror 22: the traveling direction of the reflected electromagnetic wave 50 while the mirror 22 is in the reference posture; and the traveling direction of the reflected electromagnetic wave 50 while the mirror 22 is inclined.

When the maximum clockwise and counterclockwise inclination angles of the mirror 22 are different from each other, different values of the predetermined angles may be set for the different inclination directions. The predetermined angle for the clockwise inclination of the substrate 24 of the reflection device 20 may be set to double the maximum clockwise inclination angle of the mirror 22. The predetermined angle for the counterclockwise inclination of the substrate 24 of the reflection device 20 may be set to double the maximum counterclockwise inclination angle of the mirror 22.

The substrate 24 of the reflection device 20 may be placed on the placement portions 14 so as to be inclined about an axis in a direction intersecting the first axis serving as the axis about which the mirror 22 is inclined. That is, the substrate 24 may be inclined about an axis in a direction in which the electromagnetic wave is not scanned. Also in this way, the electromagnetic wave deflection device 1 can move the scanning range 52 such that the traveling direction of the noise electromagnetic wave 60 is to the outside the scanning range 52. The traveling direction of the noise electromagnetic wave 60 is determined by the surface 30A of the transmissive member 30. The substrate 24 may be placed on the placement portions 14 so as to be inclined either about the axis in the direction in which the electromagnetic wave is scanned (axis along the first axis) or about the axis in the direction in which the electromagnetic wave is not scanned, or inclined about both of these axes.

As has been described, in the embodiment, the electromagnetic wave deflection device 1 can cause the traveling direction of the noise electromagnetic wave 60 to extend outside the scanning range 52 by inclining the reflection device 20. As a result, the noise can be reduced.

As a comparative example, in order to cause the traveling direction of the noise electromagnetic wave 60 to extend outside the scanning range 52, the following configuration is conceivable: the transmissive member 30 is inclined relative to the bottom surface 16 of the housing 10. When the transmissive member 30 is inclined relative to the bottom surface 16 of the housing 10, in joining the transmissive member 30 to the housing 10, the transmissive member 30 is required to be inclined relative to the housing 10 while the transmissive member 30 is placed on the housing 10. Various conditions in a joining process of the transmissive member 30 and the housing 10 are determined on the assumption that the transmissive member 30 substantially horizontally placed on the housing 10 is joined to the housing 10 so as to ensure the sealing performance with the transmissive member 30 and the housing 10. Accordingly, due to the joining performed while the transmissive member 30 is inclined and place on the housing 10, the sealing performance with the transmissive member 30 and the housing 10 can be reduced. If, for ensuring the sealing performance, the various conditions in the joining process are redetermined such that the various conditions conform to the inclination of the transmissive member 30, a work load for the redetermination of the conditions can be increased. Furthermore, the conditions are required to be redetermined every time the inclination angle of the transmissive member 30 is varied. This can further increase the work load.

In contrast, in the present embodiment, the electromagnetic wave deflection device 1 can cause the noise electromagnetic wave 60 to travel outside the scanning range 52 by inclining the substrate 24 of the reflection device 20 relative to the bottom surface 16 inside the housing 10 without inclining the transmissive member 30. In this way, the noise can be reduced without affecting the process of joining the transmissive member 30 to the housing 10. As a result, both reducing of noise and ensuring of the sealing performance can be realized. When the scanning range 52 is finite in distance, an effect equivalent to that of the present embodiment can also be obtained with the electromagnetic wave deflection device 1 configured to cause the noise electromagnetic wave 60 to travel to a region exceeding the distance (an extension of the scanning range 52 outside the scanning range 52).

### Other Embodiments

Hereinafter, other embodiments are described.

### Electromagnetic Wave Scanning Device

As illustrated in FIG. 3, the incident electromagnetic wave 40 may be emitted from a light source 70. The light source 70 is configured to cause the electromagnetic wave to be incident upon the transmissive member 30 at a predetermined angle. The light source 70 is also referred to as a radiation unit. A configuration including the radiation unit and the electromagnetic wave deflection device 1 is also referred to as an electromagnetic wave scanning device. The electromagnetic wave scanning device may include a controller configured to control the posture of the mirror 22 such that a predetermined range is scanned with the electromagnetic wave reflected by the mirror 22. The controller may control the posture of the mirror 22 within a range in which the reflection surface of the mirror 22 for the electromagnetic wave does not become parallel to the transmissive member 30.

The electromagnetic wave deflection device 1 or the electromagnetic wave scanning device causes the reflected electromagnetic wave 50 to travel toward a predetermined object. The reflected electromagnetic wave 50 is reflected or scattered by the predetermined object and detected by a separately provided electromagnetic wave detection device. The predetermined object is also referred to as a detection target. The electromagnetic wave detection device obtains, for example, an image of the detection target or distance data from the detection target to the electromagnetic wave detection device based on a detection result of the electromagnetic wave reflected or scattered by the detection target. The electromagnetic wave detection device may detect the electromagnetic wave from the detection target in accordance with the period of scanning of the electromagnetic wave by the electromagnetic wave deflection device 1. That is, the electromagnetic wave deflection device 1 may scan the electromagnetic wave such that the scanning of the electromagnetic wave is synchronized with timing of the detection of the electromagnetic wave by the electromagnetic wave detection device. The electromagnetic wave deflection device 1 may scan the electromagnetic wave with a predetermined period regardless of the timing of the detection of the electromagnetic wave by the electromagnetic wave detection device.

### Configuration Example in Which Mirror 22 is Inclined about Each of Two Axes

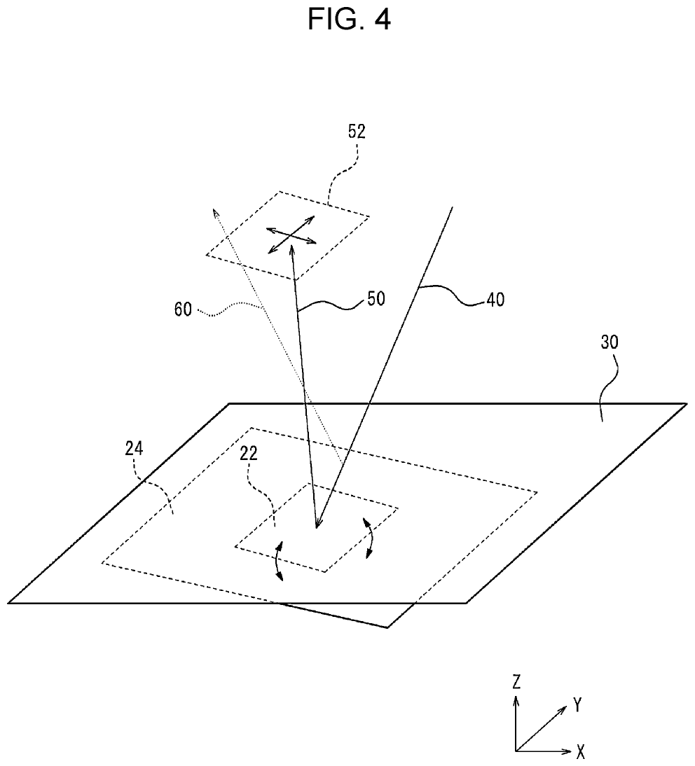

In the example illustrated in FIG. 3, the mirror 22 is inclinable about the axis extending along the Y axis. The mirror 22 may also be inclinable about an axis extending along the X axis as exemplified in FIG. 4. That is, the mirror 22 may be inclinable about each of the two axes. In other words, the mirror 22 is inclinable not only about the first axis but also about a second axis intersecting the first axis. The first axis and the second axis can be said to extend in directions along the substrate 24. When the mirror 22 is inclinable about each of the two axes, the reflected electromagnetic wave 50 is scanned in a planar manner (two-dimensionally). That is, the scanning range 52 is represented as a planar range.

The substrate 24 of the reflection device 20 may be placed on the placement portions 14 so as to be rotated and inclined about the first axis by an angle greater than a predetermined angle and may be placed on the placement portions 14 so as to be rotated and inclined about the second axis by an angle greater than a predetermined angle.

The predetermined angles are determined based on the angles by which the mirror 22 is inclined. A maximum inclination angle in the rotation of the mirror 22 about the first axis is also referred to as a first maximum inclination angle. A maximum inclination angle in the rotation of the mirror 22 about the second axis is also referred to as a second maximum inclination angle.

When the second maximum inclination angle is greater than the first maximum inclination angle, the substrate 24 of the reflection device 20 may be placed on the placement portions 14 so as to be inclined about the first axis relative to the bottom surface 16 of the housing 10 by an angle greater than double the first maximum inclination angle. In this way, the noise electromagnetic wave 60 can be outside the scanning range 52.

When the second maximum inclination angle is smaller than the first maximum inclination angle, the substrate 24 of the reflection device 20 may be placed on the placement portions 14 so as to be inclined about the second axis relative to the bottom surface 16 of the housing 10 by an angle greater than double the second maximum inclination angle. In this way, the noise electromagnetic wave 60 can be outside the scanning range 52.

When the first maximum inclination angle and the second maximum inclination angle are equal to each other, the substrate 24 of the reflection device 20 may be placed on the placement portions 14 so as to be inclined about at least one of the first axis or the second axis relative to the bottom surface 16 of the housing 10 by an angle greater than double the first maximum inclination angle (or the second maximum inclination angle). In this way, the noise electromagnetic wave 60 can be outside the scanning range 52.

The substrate 24 of the reflection device 20 may be inclined relative to the bottom surface 16 of the housing 10 about only one of the first axis or the second axis or inclined relative to the bottom surface 16 of the housing 10 about both the first axis and the second axis.

### Shape of Surface 30A of Transmissive Member 30

The electromagnetic wave deflection device 1 may be configured to set the traveling direction of the noise electromagnetic wave 60 to the outside the scanning range 52 by using the shape of the transmissive member 30. In this case, the substrate 24 of the reflection device 20 is not necessarily inclined relative to the bottom surface 16 of the housing 10 and may be substantially parallel to the bottom surface 16.

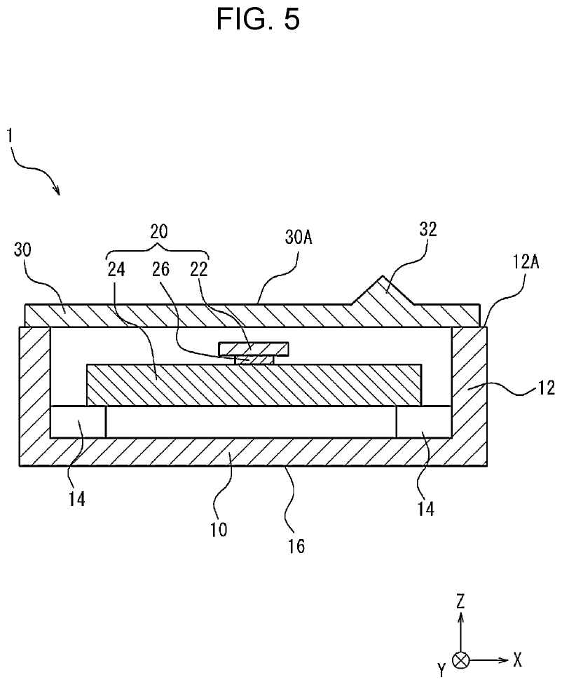

As exemplified in FIG. 5, the transmissive member 30 may include a projection 32 on the surface 30A. The substrate 24 of the reflection device 20 is assumed to be parallel to the bottom surface 16 of the housing 10. Other configurations are assumed to be the same as the configurations illustrated in FIGS. 1 and 2.

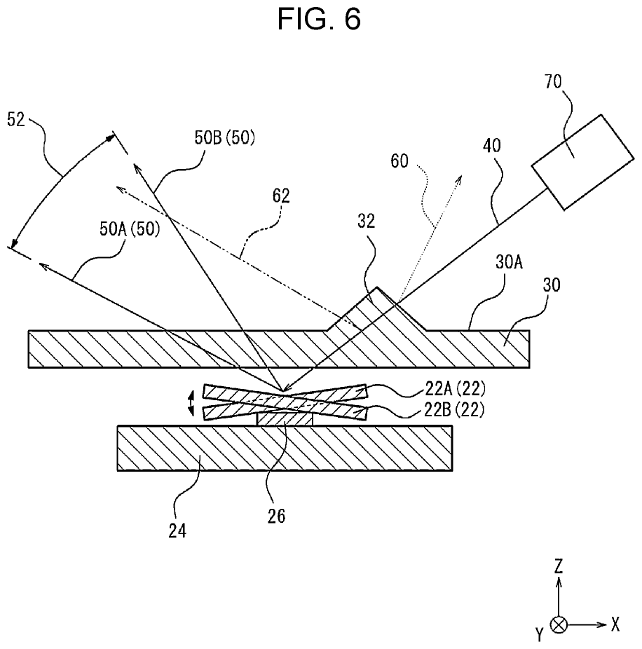

As illustrated in FIG. 6, when the transmissive member 30 includes the projection 32 at part of the surface 30A upon which the incident electromagnetic wave 40 is incident, at least part of the incident electromagnetic wave 40 from the light source 70 is incident upon the transmissive member 30 via the projection 32. The incident electromagnetic wave 40 having been incident via the projection 32 and reached the reflection device 20 is reflected by the reflection device 20. The reflected electromagnetic wave 50 travels in the direction indicated as the reflected electromagnetic wave 50A when the mirror 22 is inclined counterclockwise most as indicated as the mirror 22A. The reflected electromagnetic wave 50 travels in the direction indicated as the reflected electromagnetic wave 50B when the mirror 22 is inclined clockwise most as indicated as the mirror 22B. When the mirror 22 is inclined in the state between the state indicated as the mirror 22A and the state indicated as the mirror 22B, the reflected electromagnetic wave 50 travels in the direction between the direction of the reflected electromagnetic wave 50A and the direction of the reflected electromagnetic wave 50B. That is, the reflected electromagnetic wave 50 is scanned in the scanning range 52 between the direction of the reflected electromagnetic wave 50A and the direction of the reflected electromagnetic wave 50B due to the variation of an inclination angle of the mirror 22.

Part of the incident electromagnetic wave 40 is reflected by a surface of the projection 32 and becomes the noise electromagnetic wave 60. The electromagnetic wave deflection device 1 can cause the traveling direction of the noise electromagnetic wave 60 to extend outside the scanning range 52 when the projection 32 is included. If the projection 32 does not exist and the surface 30A of the transmissive member 30 is flat, the incident electromagnetic wave 40 reflected by the flat surface 30A travels as a provisory noise electromagnetic wave 62. The traveling direction of the provisory noise electromagnetic wave 62 can be within the scanning range 52. Accordingly, the projection 32 can be said to cause the noise electromagnetic wave 60 to travel outside the scanning range 52.

The transmissive member 30 may include a recess at part of the surface 30A upon which the incident electromagnetic wave 40 is incident. The transmissive member 30 may include an inclined surface at the part of the surface 30A upon which the incident electromagnetic wave 40 is incident. Also when the transmissive member 30 includes the recess or the inclined surface at the part of the surface 30A upon which the incident electromagnetic wave 40 is incident, the traveling direction of the noise electromagnetic wave 60 due to the incidence of the incident electromagnetic wave 40 can be outside the scanning range 52.

In the embodiment of the present disclosure, the drawings used for the description are schematic. The ratio of dimensions or the like in the drawings does not necessarily agree with the actual ratio of dimensions or the like.

Although the embodiment of the present disclosure has been described based on the various drawings and examples, it should be noted that one skilled in the art can make various changes or modifications based on the present disclosure. Accordingly, it should be noted that these changes or modifications are included in the scope of the present disclosure. For example, the functions and the like included in the configurations can be relocated without logical contradiction. A plurality of the configurations can be combined into a single configuration of divided. It should be understood that the scope of the present disclosure also includes these combined configurations or divided configurations.

In the present disclosure, the descriptions such as “first” and “second” are identifiers for distinguishing corresponding configurations. In the present disclosure, the configurations distinguished by the descriptions of “first”, “second”, and the like can exchange the numbers of the configurations. For example, the first axis and the second axis can exchange the identifiers “first” and “second” with each other. The identifiers are exchanged simultaneously. The configurations are still distinguished after the exchange of the identifiers. The identifiers may be deleted. Reference numerals are used to distinguish the configurations from which the identifiers have been deleted. In the present disclosure, it is not allowed to interpret the order of the configurations based only on the description of the identifiers such as “first” and “second” or to utilize the descriptions of the identifiers as only the reason for existence of an identifier with a small number.

In the present disclosure, the X axis, the Y axis, and the Z axis are provided for convenience of the description and may be interchanged. In the present disclosure, the configurations have been described by using the rectangular coordinate system including the X axis, the Y axis, and the Z axis. In the present disclosure, none of the positional relationships between the configurations are not limited to a rectangular relationship.

### REFERENCE SIGNS

1 electromagnetic wave deflection device
10 housing (12: side wall, 12A upper end of side wall, 14: placement portion, 16: bottom surface)
20 reflection device (22, 22A, 22B: mirror, 24: substrate, 26: driver)
30 transmissive member (30A: surface, 32: projection)
40 incident electromagnetic wave
50, 50A, 50B reflected electromagnetic wave
52 scanning range
60 noise electromagnetic wave
62 provisory noise electromagnetic wave
70 light source

1. An electromagnetic wave deflection device comprising:
a mirror configured to reflect an electromagnetic wave;
a housing that accommodates the mirror and includes an opening; and
a transmissive member provided in the opening,
wherein the transmissive member is configured to transmit at least part of the electromagnetic wave,
wherein the housing includes a bottom surface positioned on an opposite side from the opening, and
wherein the mirror is accommodated in the housing so as to be inclined relative to the bottom surface.

2. The electromagnetic wave deflection device according to claim 1,
wherein the mirror is configured to allow a posture of the mirror to be controlled so as to cause a predetermined range to be scanned with the electromagnetic wave reflected by the mirror, and
wherein the mirror is accommodated in the housing so as to cause a reflected wave of an incident electromagnetic wave reflected by a surface of the transmissive member to travel to outside of the predetermined range.

3. The electromagnetic wave deflection device according to claim 1,
wherein the mirror is configured to allow a posture of the mirror to be controlled so as not to allow a reflection surface for the electromagnetic wave to become parallel to the transmissive member.

4. The electromagnetic wave deflection device according to claim 1,
wherein the transmissive member is joined to the housing so as to be substantially parallel to the bottom surface of the housing or parallel to the bottom surface of the housing.

5. The electromagnetic wave deflection device according to claim 14, further comprising:
a substrate configured to hold the mirror; and
a placement portion on which the substrate is placed,
wherein the substrate is placed on the placement portion so as to be inclined relative to the bottom surface.

6. The electromagnetic wave deflection device according to claim 5,
wherein the mirror is configured to be inclinable about a first axis extending along the substrate, and
wherein the substrate is placed on the placement portion so as to be inclined about the first axis relative to the bottom surface by an angle greater than double a first maximum inclination angle, the first maximum inclination angle being a maximum value of an inclination angle of the mirror relative to a surface of the transmissive member when the mirror is inclined about the first axis.

7. The electromagnetic wave deflection device according to claim 6,
wherein the mirror is further configured to be inclinable about a second axis that intersects the first axis and extends along the substrate,
wherein, when a second maximum inclination angle is greater than the first maximum inclination angle, the second maximum inclination angle being a maximum value of an inclination angle of the mirror relative to the surface of the transmissive member while the mirror is inclined about the second axis, the substrate is placed on the placement portion so as to be inclined about the first axis relative to the bottom surface by an angle greater than double the first maximum inclination angle,
wherein, when the second maximum inclination angle is smaller than the first maximum inclination angle, the substrate is placed on the placement portion so as to be inclined about the second axis relative to the bottom surface by an angle greater than double the second maximum inclination angle, and
wherein, when the first maximum inclination angle and the second maximum inclination angle are equal to each other, the substrate is placed on the placement portion so as to be inclined about at least one of the first axis or the second axis relative to the bottom surface by an angle greater than double the first maximum inclination angle.

8. The electromagnetic wave deflection device according to claim 5,
wherein the mirror is configured to be inclinable about the first axis extending along the substrate, and
wherein the substrate is inclined about an axis along a direction intersecting the first axis.

9. An electromagnetic wave scanning device comprising:
the electromagnetic wave deflection device according to claim 1; and
a radiation unit configured to cause the electromagnetic wave to be incident upon the transmissive member at a predetermined angle.

10. The electromagnetic wave scanning device according to claim 9, further comprising:
a controller configured to control a posture of the mirror so as to cause a predetermined range to be scanned with the electromagnetic wave reflected by the mirror,
wherein the mirror is accommodated in the housing so as to cause a reflected wave of an incident electromagnetic wave reflected by a surface of the transmissive member to travel to outside of the predetermined range.

11. The electromagnetic wave scanning device according to claim 10,
wherein the controller controls the posture of the mirror within a range in which a reflection surface of the mirror for the electromagnetic wave does not become parallel to the transmissive member.
